(19) United States
(12) Patent Application Publication
(10) Pub. No.: US 2013/0178265 A1
(43) Pub. Date: Jul. 11, 2013

(54) BACCARAT BONUS WAGERING GAME SYSTEM AND METHOD

(71) Applicant: Daniel C. Lubin, Las Vegas, NV (US)

(72) Inventor: Daniel C. Lubin, Las Vegas, NV (US)

(21) Appl. No.: 13/737,851

(22) Filed: Jan. 9, 2013

Related U.S. Application Data
(60) Provisional application No. 61/584,727, filed on Jan. 9, 2012.

(51) Int. Cl. A63F 1/00; G07F 17/32

(52) U.S. Cl. CPC A63F 1/00; G07F 17/3293
USPC 463/12; 273/274

(57) ABSTRACT

Systems and methods for providing a bonus wagering game associated with baccarat in which wagers are won if the baccarat outcome data includes a specific statistically unlikely winning outcome for either the player hand or dealer hand, such as, either one of the player hand score or banker hand score being within a particular respective range of numbers.

### CROSS-REFERENCE TO RELATED APPLICATIONS

This application claims the benefit of U.S. Provisional Patent Application No. 61/584,727 which was filed Jan. 9, 2012, the disclosure of which is incorporated herein by reference.

### FIELD OF THE INVENTION

The invention relates generally to systems and methods of modifying, providing and conducting wagering games, and more particularly, a bonus wagering game for Baccarat.

### BACKGROUND OF THE INVENTION

Baccarat is a popular game that is oftentimes played in casino environments. It may take the form of a card table game, played with a shoe of cards that is typically an aggregation of several decks of physical playing cards, or it can be simulated as an electronic table game or an online game.

Baccarat is a card game typically played with multiple decks of standard 52-card decks. The cards may be shuffled, cut by a player (and such cut then marked with a “Cut” card), and placed in a “shoe” from which cards are dealt during play. Two community hands are dealt, a “banker side” hand and a “player side” hand. The dealing and card drawing rules of Baccarat are known and scoring in Baccarat is in modulo ten. For example, if a player hand has 2-8-6, that is, a total of 16, his Baccarat point total would be 6. A player with an Ace and a Nine would have a zero score because an Ace is worth 1, and added to 9 is 10, which is zero in modulo ten. Therefore, nine is the highest point total in Baccarat. The hand with the higher point total wins.

The Banker hand and Player hand are played against each other, and each player places one of three principal bets, that is, Player hand wins; Banker hand wins; or Tie hand.

While Baccarat is a very popular game, many new games which are quickly rising in popularity provide numerous wagering opportunities, thus increasing player participation and excitement. Conventional Baccarat lacks wagering opportunities that allow for increased payouts on statistically unlikely winning hand occurrences or specific outcomes which would be attractive to players. Consequently, there is a desire for systems and methods which would provide such wagering opportunities in the game of Baccarat.

### SUMMARY OF THE INVENTION

The invention relates generally to systems and methods of modifying, providing and conducting a bonus wagering game in connection with an underlying wagering game.

Some embodiments of the invention are directed to systems and methods of providing a bonus wagering game associated with an underlying game of baccarat in which a wager may be received that the baccarat game outcome will consist of a specific statistically unlikely winning outcome for either the player hand or dealer hand.

Some embodiments of the invention are directed to a method of providing a bonus wagering game associated with an underlying game of baccarat, comprising the steps of: displaying one or more wagering areas and indicia relating to the bonus wagering game, including a player hand bonus wagering area and a dealer hand bonus wagering area; receiving a wager in at least one of the player hand bonus wagering area or the dealer hand bonus wagering area; receiving baccarat game outcome data from an instance of conducting a game of baccarat according to its rules, wherein the baccarat game outcome data includes a player hand score and a banker hand score; comparing the baccarat game outcome data with preset winning criteria, wherein the preset winning criteria consists of either the player hand score being within a range of numbers from X1 to X2 but greater than the banker hand score and a wager being received in the player hand bonus wagering area or the banker hand score being within a range of numbers from Y1 to Y2 but greater than the player hand score and a bonus wager being received in the banker hand bonus wagering area; providing a payout if the preset criteria is satisfied; and collecting the wager received in the one or more bonus wagering areas if the preset criteria is not satisfied.

It should be understood that X1, X2, Y1 and Y2 may be any numbers from zero to nine or combinations thereof obtainable in a baccarat game outcome. Thus, X1 and Y1 may be the same or different numbers, and X2 and Y2 may be the same or different numbers. In some embodiments, X1 and Y1 both equal one, and X2 and Y2 both equal the number 5. In other embodiments, X1 and Y1 both equal one, and X2 and Y2 both equal the number 4.

In some embodiments of the aforementioned method, the step of receiving the baccarat game outcome is further comprises using a program with a random number generator. In other embodiments, this step involves using at least one randomly ordered deck of physical playing cards.

In some embodiments, the aforementioned method further includes the steps of determining the payout to be provided upon satisfying the preset winning criteria by comparing the baccarat game outcome data with payout criteria. In some embodiments, the payout criteria may define specific payout formulas, payout amounts, or portions of a jackpot to be provided upon one or more characteristics associated with the playing cards included in at least one of the player hand and the banker hand achieved in the underlying baccarat game outcome. For example, the one or more characteristics associated with playing cards may comprise all the cards of one or both the player and banker hands in the baccarat game outcome being the same suit, or the cards forming a poker hand, such as a pair, three of a kind or straight. The player or banker hand to which the payout criteria applies may be based on which of the hands are wagered on in the bonus game and satisfy the preset criteria.

Some embodiments of the invention are directed to a system or electronic platform for providing a wagering game associated with an underlying game of Baccarat, comprising a processor configured for comparing baccarat outcome data with preset winning criteria, wherein the preset winning criteria includes either the player hand score being within a range of numbers from X1 to X2 but greater than the banker hand score and a wager being confirmed as received in a player hand bonus wagering area or the banker hand score being within a range of numbers from Y1 to Y2 but greater than the player hand score and a bonus wager being confirmed as received in a banker hand bonus wagering area; and a communication interface configured for: displaying one or more wagering areas and indicia relating to the bonus wagering game, including the player hand bonus wagering area and the dealer hand bonus wagering area; receiving an indication of a wager placed in at least one of the player hand bonus wagering area or the dealer hand bonus wagering area; receiving baccarat game outcome data from an instance of conducting a game of baccarat according to its rules, wherein the baccarat game outcome data includes the player hand score and the banker hand score; providing a notification of a payout if the preset criteria is satisfied or a notification of collection of the wager received in the one or more bonus wagering areas if the preset criteria is not satisfied.

In some embodiments, the processor conducts the underlying game of baccarat until a baccarat outcome is achieved according to the rules of the baccarat game. In other embodiments, real-time game play of the underlying game of baccarat is displayed through the communication interface. The communication interface and processor may be mounted in a unitary housing, or the processor may be remotely located from the communication interface.

Some embodiments of the invention are directed to computer-implemented methods of providing a wagering game associated with an underlying baccarat game, comprising one or more processors, communication devices and data storage devices, all for facilitating the steps of: receiving information relating to a bonus wager placed by a player in a bonus wagering game, including a designation of at least one of a player hand bonus wager and a banker hand bonus wager; transmitting information to the player relating to play of the baccarat game; receiving information relating to the baccarat game outcome; determining if the bonus wager placed has satisfied preset winning criteria, wherein the preset winning criteria consists of either the player hand score being within a range of numbers from X1 to X2 but greater than the banker hand score and receipt of a designation of a player hand bonus wager being placed or the banker hand score being within a range of numbers from Y1 to Y2 but greater than the player hand score and receipt of a designation of a banker hand bonus wager being placed; and transmitting information to the participating player relating to the outcome of the bonus wager designation, wherein the information transmitted either includes a notification of the awarding of a payout amount or

The communication interface may be a data input and/or data output device or a remote computer terminal, such as a home computer or mobile device with access to local or global network. The system and communication interface may be configured for providing the associated wagering game to players via an online system or the Internet. The processor may also be remotely located from the player interface. In some embodiments, the communication interface, processor and display device may be mounted within a unitary housing, and the aforementioned system may be an electronic gaming machine or electronic platform including multiple data input devices providing player positions. In some embodiments, the system may include one or more kiosks for viewing a baccarat game being played and providing associated wagering game methods as described herein.

Some embodiments of the invention are also directed to a non-transitory machine readable media for providing a bonus wagering game associated with a baccarat game including one or more software programs, code and/or data segments as necessary to provide any of the methods described herein on one or more machines. For example, the aforementioned machine readable media may include code and/or data segments for conducting a wagering game associated with the underlying game of Baccarat, which includes the steps of: receiving a wager relating to the associated wagering game; generating a random initial hand of playing cards in the underlying game for a player and a banker; determining the final outcome of the underlying game according its rules, wherein the final outcome may be a player win, a banker win or a tie hand; comparing the final outcome with a winning preset criteria, wherein the winning preset criteria includes placing the wager on a player or banker hand which wins the underlying game with a hand value in the underlying game of four or less, providing a payout corresponding with the wager received if the winning preset criteria are satisfied. The payout may be any item of benefit to the player, such as fixed monetary amount, odds payout based on a multiple of the unit wagered, award or portion of a progressive bonus.

In some embodiments, the aforementioned machine readable media may also include software programs, code and/or data segments as necessary to perform any of the methods described herein or to facilitate the installation and operation of software programs to provide methods in a system as described herein.

### BRIEF DESCRIPTION OF THE DRAWINGS

FIG. 1 is a process flow chart depicting an exemplary embodiment of the invention.

FIG. 2 is a schematic diagram of an exemplary table layout configured for use with methods according to some embodiments of the invention, including physical or live table systems and virtual or partially virtual electronic platforms.

FIG. 3 is a schematic diagram of exemplary system components configured for use with methods according to some embodiments of the invention.

### DETAILED DESCRIPTION OF THE INVENTION

The exemplary embodiments herein relate to wagering games such as Baccarat or Blackjack or variants and modifications thereof in which additional “side” bonus wagers other than the underlying game wagers for such games are placed by players and received by the house or casino, or a person or entity acting as a banker of the game, to be subsequently resolved in a secondary, associated or bonus wagering game which is resolved at least in part through application of the randomly generated outcome of the underlying game.

Unless stated otherwise, all references in the specification that are made to “cards”, “decks”, “dealing”, “hands” or other such expressions that are ordinarily used in describing a wagering game that is played with physical playing cards are also meant to describe and capture all associated electronic and online representations of said physical playing cards, including their associated graphical and numeric card symbols (for instance, suits such as hearts, spades, diamonds or clubs, face cards such as jacks, queens and kings, and the aces and other numbered cards of a typical playing deck). These expressions are also meant to extend as well to all forms of transmission of data, electronic dealing, delivery, distribution or allocation of the said card symbols, according to the rules of the underlying wagering game.

It should further be understood that the invention is directed to, among other things, methods of providing, conducting and resolving wagering games that include a sequence of controlled and concrete transformative events. Some of these events may involve wagering or transmission thereof, the generation of random data, the application of randomly-generated data to predefined rules, the determination of wager outcomes in accordance with preset outcome determining criteria, the notification of such outcomes, awarding of payouts and collecting of wagers. The generation of random data may be facilitated by computerized and/or physical implements. The transformative events may also include parsing of the data for comparative purposes with preset criteria to determine an outcome in a second, bonus or associated wagering game according to the invention.

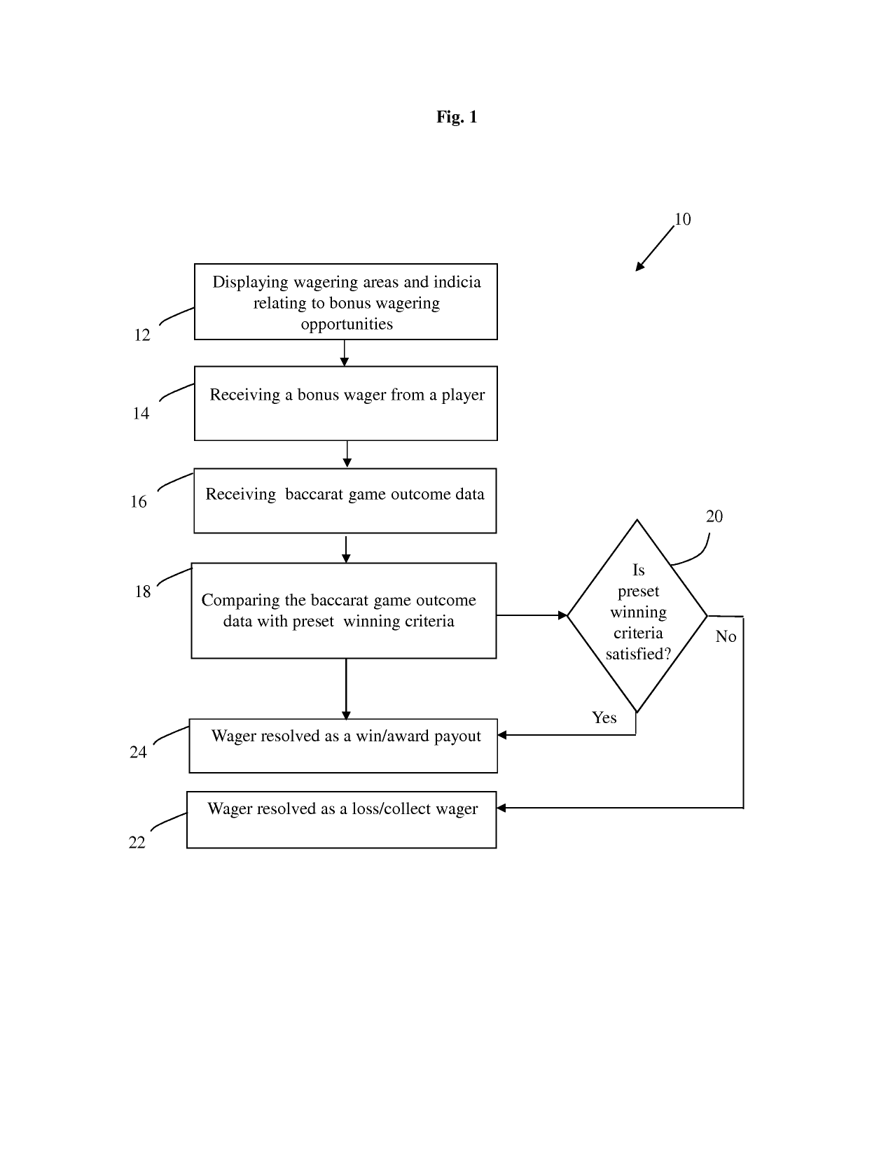

A method of conducting a wagering game associated with an underlying game of baccarat according to some embodiments of the invention is generally referred to by the reference numeral 10 in FIG. 1.

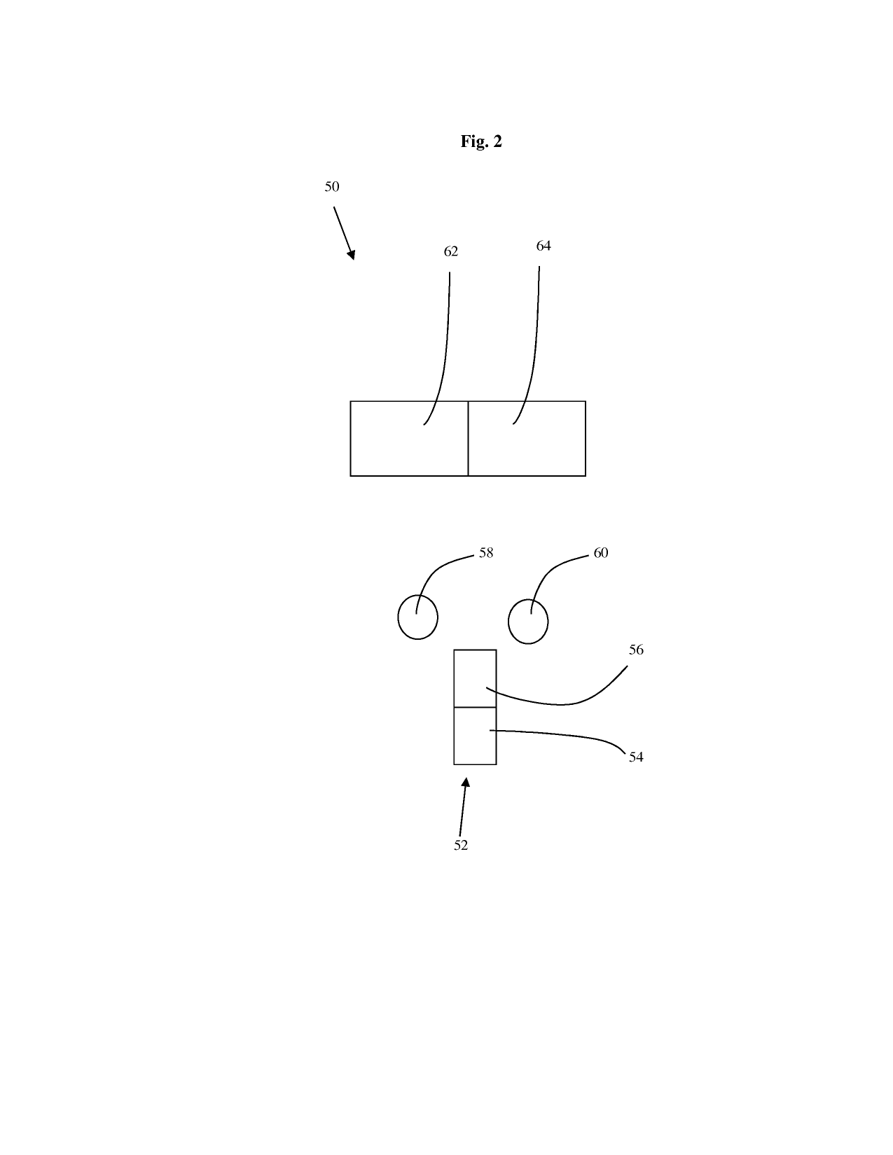

As shown by step 12, method 10 may be facilitated by providing a table layout such as layout 50 shown in FIG. 2 so that wagering areas and indicia relating to bonus wagering opportunities according to the invention may be displayed to potential players and used for the placement of wagers thereon. The display or layout may include a player hand bonus wagering area and a dealer hand bonus wagering area for each player.

In step 14, one or more bonus wagers are received by a player interested in playing the associated bonus game. In particular, a player hand bonus wager, a dealer hand bonus wager, or both, will be received in step 14, thus identifying the bonus wagering opportunity selected. In this embodiment, placing a bonus wager is optional, and may be received along with a wager in the underlying baccarat game. However, in other embodiments, the bonus wager placed in step 14 may be mandatory, along with a wager received in the underlying baccarat game, so that the player must place wagers in both the underlying baccarat game and associated bonus game.

In step 16, the underlying baccarat game is played or operated until a game outcome is achieved according to the rules of the underlying baccarat game and received according to the invention, either as interim information as game play occurs or subsequent to the game outcome determination. For example, regardless of the version of baccarat, the baccarat game will be carried out until an outcome is achieved in which the player hand win, banker hand win or tie. It should be understood that the underlying game and associated game may be conducted at the same or different locations and/or time, so long as baccarat game outcome data is received.

It should further be understood that step 16 may incorporate various additional steps, such as the randomizing of one or more a set of playing cards, the grouping of the playing cards into a card distributing holder or shoe, the provision of the shoe to a table, and the dealing of cards from the shoe. Additionally, step 16 may also incorporate steps involving the receipt, processing and transmission of playing card information, game play or game outcome data from a live, simulated or computer actuated baccarat game. For example, the game outcome of the underlying game obtained in step 18 may be stored in memory, displayed through physical cards, automatically determined such as by a card reading camera or other card reading baccarat card shoe, or input by a dealer, for the purpose of facilitating the invention.

In step 18, data describing the underlying baccarat game outcome is compared with preset winning criteria for resolving the wager received in connection with the underlying game in step 14.

The preset winning criteria relates to the bonus wager placed and baccarat game outcome results, in that the preset criteria is satisfied if a bonus wager is received in step 14 in connection with the player hand bonus wagering opportunity and the player hand score is both within a subset of possible scores identified by the range of numbers from X1 to X2 and greater than the banker hand score (i.e., the underlying baccarat game outcome is a player hand or side win), or if a bonus wager is received in step 14 in connection with the banker hand bonus wagering opportunity and the banker hand score is both within a subset of possible scores identified by the range of numbers from Y1 to Y2 and greater than the player hand score (i.e., the underlying baccarat game outcome is a banker hand or side win). In some embodiments, the subset defined by Y1 to Y2 is less than the subset defined by X1 to X2 by at least one. In some embodiments X1 and Y1 are equal numbers (“N”), such as one. In some embodiments X1 and Y1 are equal numbers (“N1”), whereas Y2 is one less than X2, such as X2 equaling five and Y2 equaling four. In some embodiments, X2 and Y2 are equal numbers (“N2”), such as four. Alternatively, N1 may be two and N2 may be four, or N1 may be one and N2 may be five.

It should be readily apparent that the preset criteria may vary and be modified in accordance with the invention and depending on the data obtainable from the underlying game outcome.

As shown by step 20, if the data obtained from the underlying game outcome does not satisfy the preset criteria, then the outcome of the associated game is determined to be a loss and the wager received in step 14 is collected in step 22.

As also shown by step 20, if the data obtained from the underlying game outcome satisfies the preset criteria, then the outcome of the associated game is determined to be a win, the wager received in step 14 is resolved as such and a payout is provided in step 24. The payout in step 24 may be anything of value, such as a fixed amount, a multiple of the wager received in step 14, an odds-based payout, all or a portion of an incremented progressive award or a prize.

It should be readily apparent that many variations of the preset criteria and payouts may be advantageously employed in embodiments of the invention.

In some embodiments, the specific payout amount provided in step 24 is at least partially determined by the specific player hand score or specific banker hand score within the respective subset that satisfies the preset winning criteria. In some embodiments, the payout amount may also be partially dependent on characteristics of the specific cards in either one of the player and banker hands or both at the outcome of the game, which may be provided in the game outcome data, such as the suits of cards in one or both of the hands, the rank or number of the cards in one or both of the hands, the number of cards in one or both of the hands.

The tables below illustrates an exemplary embodiment in which the payout amount is at least partially determined by the specific player hand score or specific banker hand score within the respective subset that satisfies the preset winning criteria. In this embodiment, X1 and Y1 are one, Y2 is five and X2 is four. Thus, the preset winning criteria for bonus wagers received in this embodiment is as follows: a bonus wager received in connection with the player hand bonus wagering opportunity wins if the player hand score is both within a subset of possible scores identified by the range of numbers from one to five and greater than the banker hand score; and a bonus wager received in connection with the banker hand bonus wagering opportunity wins if the banker hand score is both within a subset of possible scores identified by the range of numbers from one to four and greater than the player hand score.

A table identifying the payout amounts as a function of the unit wagered on the player hand bonus opportunity is shown below. As shown in the table, if the preset winning criteria for with respect to the player hand wagering opportunity is satisfied, that is, a player hand score between one to five which is higher than the banker hand score (i.e., a player hand win), then the resulting payout amount depends on the specific player hand score achieved in the underlying baccarat game. In this embodiment, the payout amount is also partially dependent on characteristics associated with the specific cards in the player hand, namely the respective suits of the cards in the player hand.

| Player Hand win: | Payout: |
|---|---|
| Player hand score of 1 (cards all spades) | 500:1 |
| Player hand score of 1 (suited) | 200:1 |
| Player hand score of 1 (any suit) | 30:1 |
| Player hand score of 2 | 20:1 |
| Player hand score of 3 | 12:1 |
| Player hand score of 4 | 8:1 |
| Player hand score of 5 | 5:1 |
| Player hand score of 6 or more | loss |

A table identifying the payout amounts as a function of the unit wagered on the banker hand bonus opportunity is shown below. As shown in the table, if the preset winning criteria for with respect to the banker hand wagering opportunity is satisfied, that is, a banker hand score between one to four which is higher than the player hand score (i.e., a banker hand win), then the resulting payout amount depends on the specific banker hand score achieved in the underlying baccarat game. In this embodiment, the payout amount is also partially dependent on characteristics associated with the specific cards in the banker hand, namely the respective suits of the cards in the player hand.

| Banker Hand win: | Payout: |
|---|---|
| Banker hand score of 1 (cards all spades) | 500:1 |
| Banker hand score of 1 (suited) | 200:1 |
| Banker hand score of 1 (any suit) | 30:1 |
| Banker hand score of 2 | 20:1 |
| Banker hand score of 3 | 12:1 |
| Banker hand score of 4 | 8:1 |
| Banker hand score of 5 or more | loss |

In another embodiment, X1 and Y1 are one and Y2 and X2 are three. Thus, the preset winning criteria for bonus wagers received in this embodiment is as follows: a bonus wager received in connection with the player hand bonus wagering opportunity wins if the player hand score is both within a subset of possible scores identified by the range of numbers from one to three and greater than the banker hand score; and a bonus wager received in connection with the banker hand bonus wagering opportunity wins if the banker hand score is both within a subset of possible scores identified by the range of numbers from one to three and greater than the player hand score. As shown in the table below, in this embodiment the payout amounts are expressed as monetary amounts or portions of a progressive jackpot. The payout amounts are also at least partially determined by characteristics of the specific cards in the one selected hand, either player or banker, or both of the player and banker hands, involved in the baccarat game outcome. Wagers may be received from players selecting the player or banker hand bonus wagering opportunities, or both, which will then be compared with the preset criteria. If the preset criteria is satisfied the payout amount will be determined based on the player and/or banker hand selected by the wager placed and the characteristics of the cards in either the selected hand or both as shown in the table.

| Player hand and/or Banker Hand wager wins: | Payout | Frequency |
|---|---|---|
| Selected hand score of 1 (both hands all | 100% | 1 in 955,000 |
| spades) | | |
| Selected hand score of 1 in spades other hand | 10% | 1 in 219,000 |
| suited (non-spades) | | |
| Selected hand score of 1 in spades | $1000 | 1 in 13,500 |
| Selected hand score of 1 suited (non-spades) | $200 | 1 in 3,400 |
| Selected hand score of 1 | $30 | 1 in 205 |
| Selected hand score of 2 | $20 | 1 in 73 |
| Selected hand score of 3 | $10 | 1 in 36 |

As mentioned above, layout 50 shown in FIG. 2 is intended to facilitate play of a method according to the invention, such as method 10. Layout 50 includes a player interface or position 52. It should be understood that layout 50 may include a plurality of player positions 52, depending, for example, on whether layout 50 is used in a live table game format in which there would be multiple players seated at the gaming table, or is electronically provided at a gaming kiosk provided for individual players. Layout 50 may be a physical or virtual representation of a felt table display, as it should be understood that the methods of the invention would function as described herein if any one or more of the layout, cards, dealers or wagering chips or apparatus were virtually or physically represented. In this embodiment, each player position 52 includes a player hand wagering position 54, a banker hand wagering position 56, a bonus game wagering position 58 for wagering on the player hand bonus wagering opportunity, and a bonus game wagering position 60 for wagering on the banker hand bonus wagering opportunity. Layout 50 further includes a player hand card position 62 and a banker hand card position 64 for forming the respective player and banker hands during game play of the underlying baccarat game or providing a display thereof as game play occurs. It should be understood that player interface 52 may be an electronic device. It should also be understood that the exact location of the wagering areas and configuration of layout 50 may differ.

In some embodiments, the layout 50 may entirely be provided via a computer interface. Alternatively, the game methods according to the invention may be implemented and presented by means of computer program code which, by way of example, when executed by a processor, causes the display of the wagering options described herein and a game layout.

Those skilled in the art will readily appreciate that the methods described herein may be incorporated in an electronic gaming system in accordance with the invention using virtual representations of table layouts such as layout 50. The system of the invention may include various computer and network related software and hardware, such as programs, operating systems, memory storage devices, data input/output devices, data processors, servers with links to data communication systems, wireless or otherwise, and data transceiving terminals. Those skilled in the art will further appreciate that the precise types of software and hardware used are not vital to the full implementation of the methods of the invention so long as players and operators thereof are provided with useful access thereto, either through a gaming platform, or a mobile device or other computing platform via a global telecommunication network.

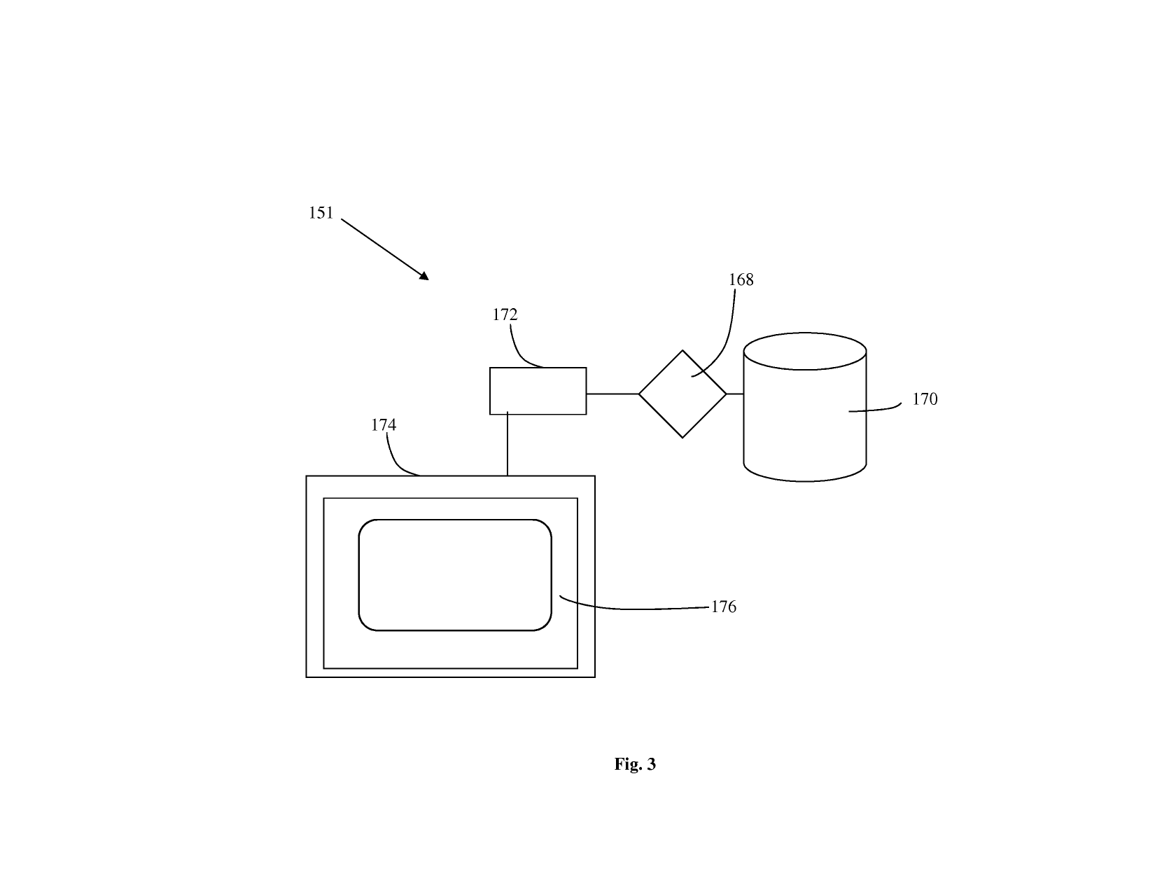

FIG. 3 illustrates an exemplary system 151 constructed in accordance with some embodiments of the invention. System 151 includes processing device 168 in communication with a database or memory device 170, communication or data input/output device 172 and a display device 174. In some embodiments, display device 174 is a touch-enabled device and includes a data input device component. Memory device 170 may include data relating to the underlying game and embodiments of the invention as described herein, such as the preset criteria. A virtual representation of a layout such as layout 50 and one or more player positions 176 may be displayed on display device 174 for facilitating the transmittal and receipt of wagers in accordance with any of the embodiments herein, such as method 10. Game outcomes may be received from a live table game or generated by a random number generator. Game outcomes are displayed and wagers are tracked using display device 174 and processing device 168 compares the underlying game outcome with the preset criteria, storing information relating to the satisfaction of the preset criteria in memory 170. Processing device 168 compares the preset criteria with the underlying game outcome stored in memory 170. Should the preset criteria be satisfied, a payout will be determined by processing device 168 and indicated on display device 174. If the preset criteria are not satisfied, the same is indicated on display device 174.

It should be understood that each of the methods and individual steps recited herein may be partially or wholly carried out in a variety of ways and/or systems, which may include, but are not limited to, a live dealer physically dealing playing cards in a casino, an electronic gaming machine (EGM) for use by one or more players, a multiplayer platform which may include a player interface such as a touchscreen display and involve physical or virtual playing cards, dealer and wagering chips, a home computer or portable computing device, such as a tablet computer or mobile phone capable of communicating with a network or over the Internet, global telecommunication network or world wide web. It should further be understood that the methods and systems of the invention are described herein in connection with a conventional baccarat game for illustrative purposes only, as the methods and systems of the invention may be employed, combined or integrated with modified, variant or otherwise non-conventional baccarat games.

While exemplary systems and methods, and applications of methods of the invention, have been described herein, it should also be understood that the foregoing is only illustrative of a few particular embodiments with exemplary and/or preferred features, as well as principles of the invention, and that various modifications can be made by those skilled in the art without departing from the scope and spirit of the invention. Therefore, the described embodiments should not be considered as limiting of the scope of the invention in any way. Accordingly, the invention embraces alternatives, modifications and variations which fall within the spirit and scope of the invention as set forth in the claims and equivalents thereto.

What is claimed is:

1. A method of providing a bonus wagering game associated with an underlying game of baccarat, comprising the steps of:
displaying one or more wagering areas and indicia relating to bonus wagering opportunities, including displaying a wagering area for wagering on a player hand bonus wagering opportunity and a banker hand bonus wagering opportunity;
receiving a wager associated with at least one of the player hand bonus wagering opportunity or banker hand bonus wagering opportunity;
receiving baccarat game outcome data from an instance of conducting a game of baccarat according to its rules, wherein the underlying game outcome includes data relating to a player hand score and a banker hand score;
comparing the baccarat game outcome data with preset winning criteria, wherein the preset winning criteria includes either one of the player hand score being within a range of numbers from X1 to X2, greater than the banker hand score and a wager being received in the player hand bonus wagering area or the banker hand score being within a range of numbers from Y1 to Y2, greater than the player hand score and a bonus wager being received in the banker hand bonus wagering area;
providing a payout if the preset winning criteria is satisfied by the baccarat game outcome data; and
collecting the wager if the preset winning criteria is not satisfied by the baccarat game outcome data.

2. A method as recited in claim 1, wherein X1 and Y1 are equal.

3. A method as recited in claim 1, wherein X1 and Y1 are the number one.

4. A method as recited in claim 1, wherein Y2 and X2 are equal.

5. A method as recited in claim 1, wherein X1 to X2 defines a greater range of numbers than the range of numbers defined by Y1 to Y2.

6. A method as recited in claim 1, wherein Y2 is four and X2 is five.

7. A method as recited in claim 1, wherein the step of receiving game outcome data is achieved further comprising using at least one randomly ordered deck of physical playing cards for conducting the underlying game.

8. A method as recited in claim 1, further comprising the steps of determining the payout to be provided upon satisfying the preset winning criteria by comparing the baccarat game outcome data with payout criteria, wherein the payout criteria defines specific payout amounts to be provided upon one or more characteristics associated with playing cards being included in at least one of the player hand and the banker hand.

9. A method as recited in claim 8, wherein the one or more characteristics associated with playing cards comprise all the cards being the same suit.

10. A system for providing a wagering game associated with an underlying game of Baccarat, comprising:
a) a processor configured for comparing baccarat game outcome data with preset winning criteria, wherein the preset winning criteria includes either one of the player hand score being within a range of numbers from X1 to X2, greater than the banker hand score and a wager being received in a player hand bonus wagering area or the banker hand score being within a range of numbers from Y1 to Y2, greater than the player hand score and a bonus wager being received in a banker hand bonus wagering area; and
b) a communication interface configured for:
(i) displaying one or more wagering areas and indicia relating to bonus wagering opportunities, including displaying a wagering area for wagering on a player hand bonus wagering opportunity and a banker hand bonus wagering opportunity;
(ii) receiving a wager associated with at least one of the player hand bonus wagering opportunity or the banker hand bonus wagering opportunity;
(iii) receiving baccarat outcome data relating to an instance of conducting a game of baccarat until a baccarat outcome is achieved according to the rules of the baccarat game;
(iv) displaying a notification that the wager is collected if the preset criteria is not satisfied by the baccarat outcome data; and
(v) displaying a notification that the wager is paid according to an odds payout if the preset criteria is satisfied by the baccarat outcome data.

11. A system as recited in claim 10, wherein a processor conducts the underlying game of baccarat until a baccarat outcome is achieved according to the rules of the baccarat game.

12. A system as recited in claim 10, wherein real-time game play of the underlying game of baccarat is displayed through the communication interface.

13. A system as recited in claim 10, wherein the communication interface and processor are mounted in a unitary housing.

14. A system according to claim 10, wherein the processor is remotely located from the communication interface.

15. A computer-implemented method of providing a wagering game associated with an underlying baccarat game, comprising one or more processors, communication devices and data storage devices, all for facilitating the steps of:
displaying one or more wagering areas and indicia relating to bonus wagering opportunities, including displaying a wagering area for wagering on a player hand bonus wagering opportunity and a banker hand bonus wagering opportunity;
receiving a wager associated with at least one of the player hand bonus wagering opportunity or banker hand bonus wagering opportunity;
receiving baccarat game outcome data from an instance of conducting a game of baccarat according to its rules, wherein the underlying game outcome includes data relating to a player hand score and a banker hand score;
comparing the baccarat game outcome data with preset winning criteria, wherein the preset winning criteria includes either one of the player hand score being within a range of numbers from X1 to X2, greater than the banker hand score and a wager being received in the player hand bonus wagering area or the banker hand score being within a range of numbers from Y1 to Y2, greater than the player hand score and a bonus wager being received in the banker hand bonus wagering area;
providing a payout if the preset winning criteria is satisfied by the baccarat game outcome data; and
collecting the wager if the preset winning criteria is not satisfied by the baccarat game outcome data.

16. The computer-implemented method according to claim 15, wherein the communication devices transmit information via a global computing network.

17. The computer-implemented method according to claim 15, wherein the communication devices transmit information via a satellite network.
